(19) United States
(12) Patent Application Publication
(10) Pub. No.: US 2007/0079248 A1
(43) Pub. Date: Apr. 5, 2007

(54) Automation tool to create text email with purchase order data out of purchase order business object

(76) Inventors: Sabine Finke, Karlsruhe (DE); Ramin Bagheri, Schwetzingen (DE); Martina Rothley, Schwetzingen (DE)

Correspondence Address: KENYON & KENYON LLP, 1500 K STREET N.W., SUITE 700, WASHINGTON, DC, 20005, US

(21) Appl. No.: 11/239,155

(22) Filed: Sep. 30, 2005

(51) Int. Cl. G06Q 20/00

(52) U.S. Cl. 715/752; 705/24; 705/17

(57) ABSTRACT

In a purchase order management system, with each purchase order request, a user can indicate to the computer to send a purchase order request to a supplier. A conventional groupware e-mail editor pops up with the data of the purchase order already embedded as text. The purchaser can add or change some data and send it to the designated supplier. The system may also extract the e-mail recipient destination address from the purchase order request record, or by comparing information in the order with address information in a database, automatically filling in the “to” and “subject” fields of the e-mail. The salutation and signature of the e-mail may also be automatically generated.

### BACKGROUND

In the field of business automation software, a business object is a software abstraction that represents an entity in the real business world. For example, a business object can represent a business transactions such as a purchase order, a contract, a policy, or a loan. Each business object has elements that can be modeled to capture business data.

The inner structure of a business object is ordinarily concealed from a user. A business object may comprise persistent data (e.g., data tied to a database) and embedded business logic. The business logic is composed of machine-executable instructions which govern the behavior and properties of the object, including how the data is organized for presentation and the inter-relationship of data. Properties of the object may represent the attributes of the entity in the real business world, providing business “meaning” behind object data. For example, a Sales Order object can have properties like order number, order date, and quantity. The business logic may also include machine-executable instructions for performing specific operations such as the manipulation and validation of data. For example, the Sales Order object can include an embedded method to calculate and get the line-items total.

With existing business software solutions, users may desire to forward the content of a business object to another party by e-mail. For example, in current purchasing processes used in business, many purchasers want to send a copy of their purchase orders via e-mail to their suppliers.

Conventional solutions are fairly limited. With some systems, it is possible to add the business object to an e-mail as an attachment. However, a drawback of this solution is that the recipient must have the appropriate application program to render the attachment. Moreover, with businesses people increasingly reliant on personal digital assistants and cell phones to receive e-mail, the use of attachments may prevent or delay dissemination of the enclosed information. The only work-around available is for a user to manually enter the relevant data into an e-mail editor. While manual entry better assures a prompt review of the information, manual entry itself takes time and is inconvenient.

### BRIEF DESCRIPTION OF THE DRAWINGS

FIG. 1-9 illustrate a method for exporting data from a business object into an e-mail program as text via an API.

FIG. 10 illustrates a block diagram of a computer system implementing the method of FIGS. 1-9.

### DETAILED DESCRIPTION

In a purchase order management system, with each purchase order request, a user can indicate to the computer to send a purchase order request to a supplier. A conventional groupware e-mail editor pops up with the data of the purchase order already embedded as text. The purchaser can add or change some data and send it to the designated supplier. The system may also extract the e-mail recipient destination address from the purchase order request record, or by comparing information in the order with address information in a database, automatically filling in the “to” and “subject” fields of the e-mail. The salutation and signature of the e-mail may also be automatically generated.

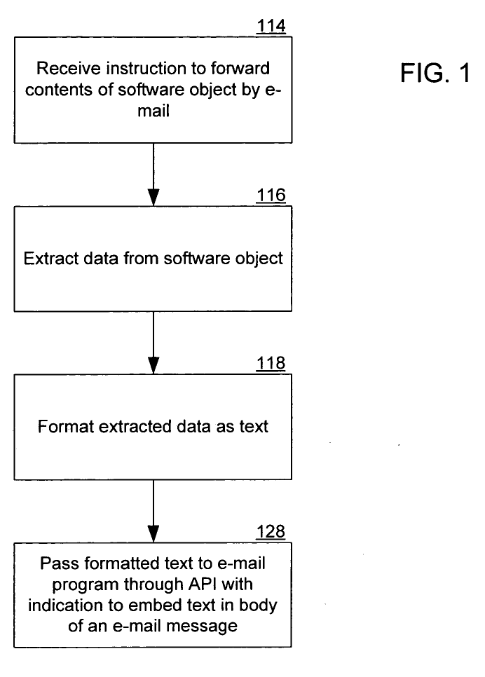

FIGS. 1-9 illustrate a method for exporting data from a business object into an e-mail program via an API.

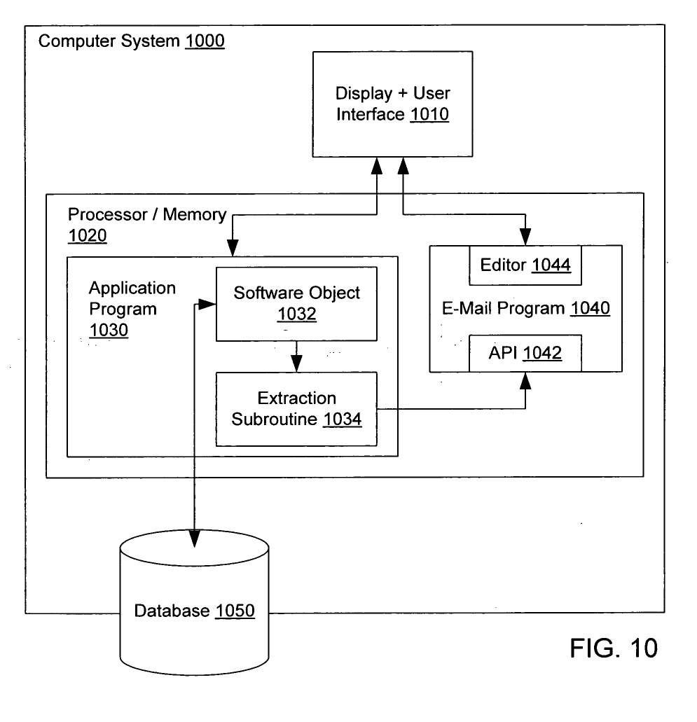

Referring to FIG. 1, responsive to receiving an instruction to forward contents of a software object by e-mail (114), data is extracted (116) from the software object (1032 in FIG. 10). The extracted data is then formatted as text (118). The formatted text is passed to an e-mail program through an application program interface (API) with an indication to embed text in the body of an e-mail message. The API (1042 in FIG. 10) may be, for example, a Messaging Application Programming Interface, an Exchange Data Objects (EDO) interface, and/or a Collaboration Data Objects (CDO) interfaces, all of which are associated with Microsoft e-mail.

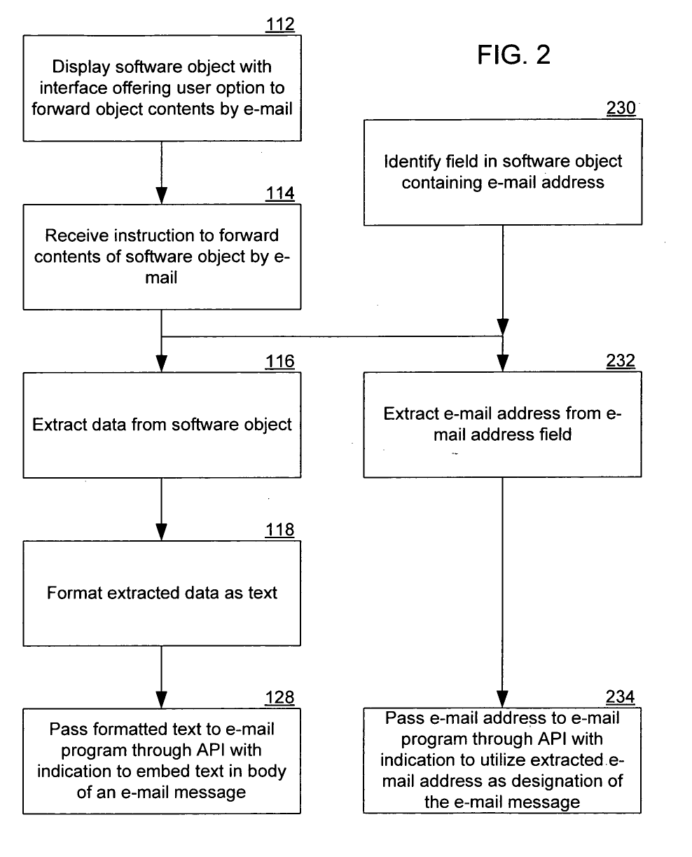

FIGS. 2-9 illustrate additional aspects of the method. In FIG. 2, the software object is displayed (112) for a user with an interface offering the user an option to forward object contents by e-mail. The display and user interface appear as 1010 in FIG. 10.

FIG. 2 illustrates an automatic routine for addressing the e-mail. A field in the business object may be identified (230) as containing an e-mail address. This step of identifying may be performed, for example, by including a tag in the business object, by designating a particular field via a preferences interface, by prompting a user to identify which field of the object should be used as the e-mail address, and/or by scanning the fields of the object looking for data having the format of an e-mail addresses. The e-mail address data is extracted (232) from the identified e-mail address field. The extracted e-mail address data is passed (234) to the e-mail program through the application programming interface with an indication to utilize the extracted e-mail address data as a destination address of the e-mail message.

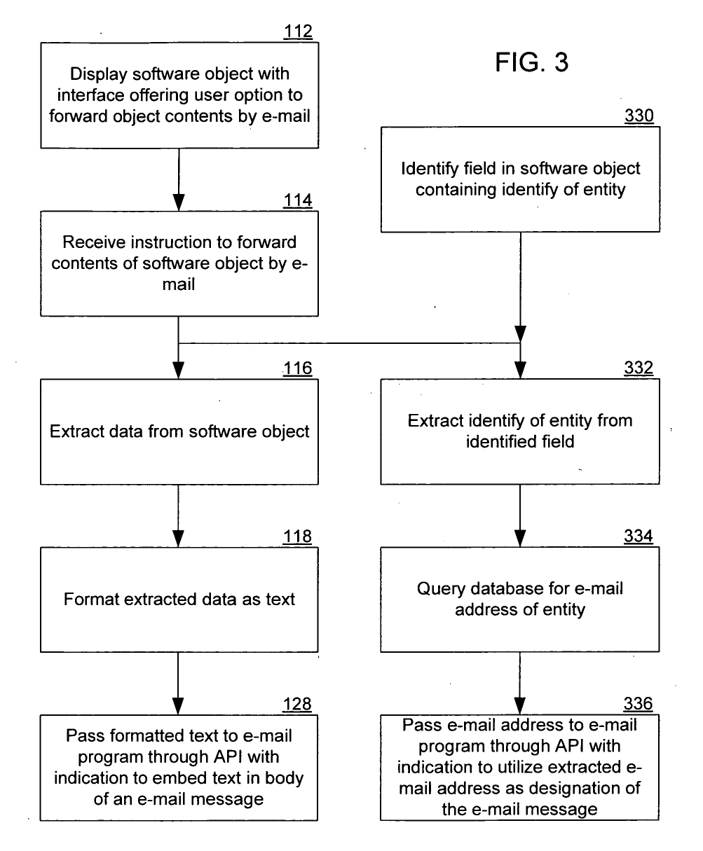

FIG. 3 illustrates an automatic routine for addressing the e-mail as an alternative to the routine in FIG. 2. A field of the business object may be identified (330) as containing an identity of an entity (e.g., person or company). This step of identifying may be performed, for example, by including a tag in the business object, by designating a particular field via a preferences interface, and/or by prompting a user to identify which field of the object contains an identity of the entity. The identity of the entity is extracted (332) from the identified entity identity field. A query is then sent (334) to a database (1060 in FIG. 10) for e-mail address data for the identified entity, providing the extracted identity of the entity to the database in the query.

Responsive to receiving the e-mail address data for the entity from the database, the e-mail address data is passed (336) to the e-mail program through the application programming interface with an indication to utilize the e-mail address data as a destination address of the e-mail message.

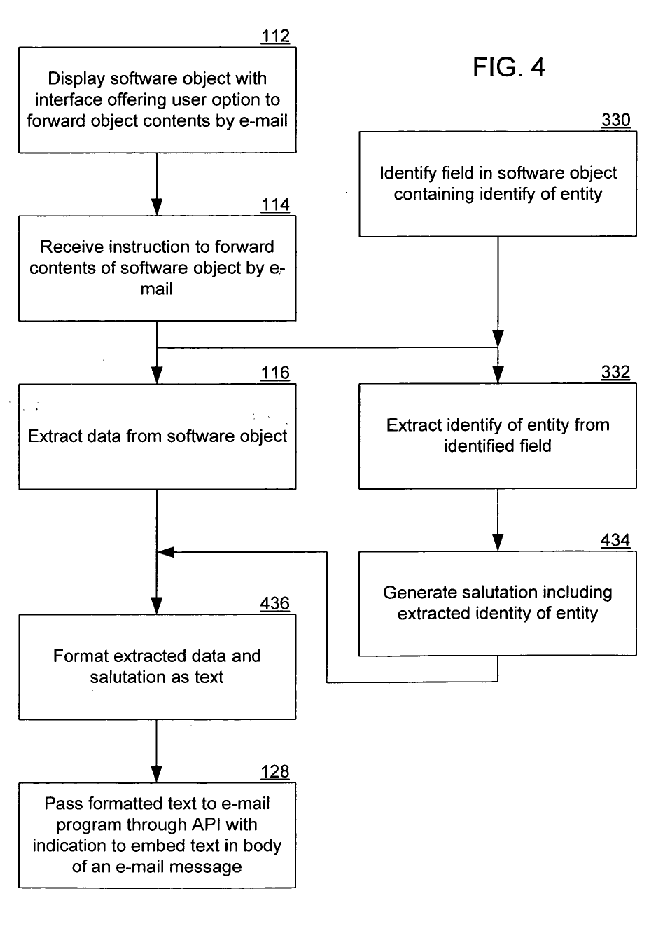

FIG. 4 illustrates an automatic routine for adding a salutation to the e-mail. As in FIG. 3, a field of the business object is identified (330) as containing an identity of an entity. The identity of the entity is extracted (332) from the identified entity identity field. A salutation generated (434) to include the identity of the entity, which is then included in the formatted text (436) to be embedded in the e-mail message.

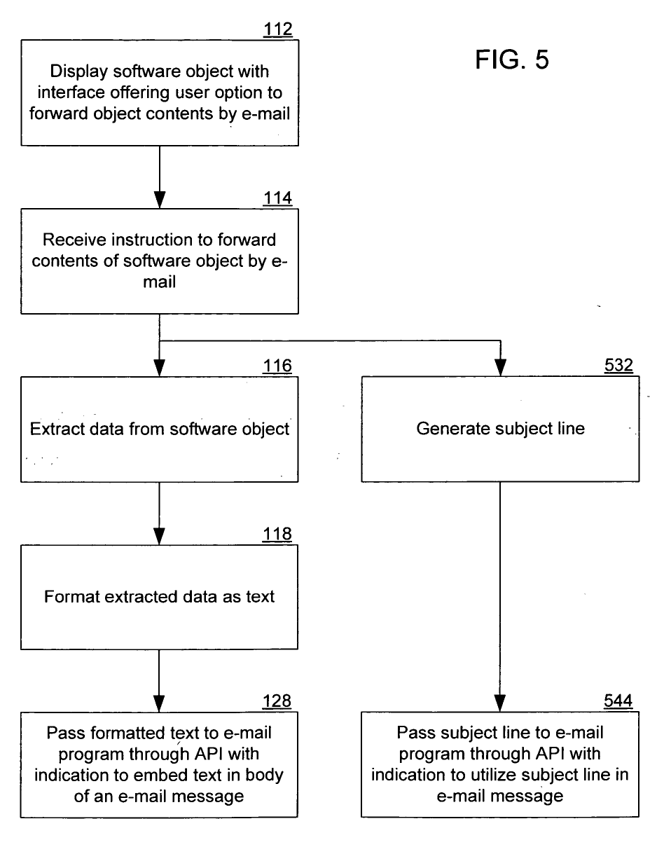

FIG. 5 illustrates an automatic routine for adding a subject line to the e-mail. Responsive to receiving the instruction to forward the contents of the business object by e-mail (114), subject line data for the e-mail message is generated (532) based upon data in the software object. For example, data from one or more fields may be extracted and used to form the subject line data. The subject line data is then passed (544) to the e-mail program through the application programming interface with an indication to utilize the subject line data as a subject line of the e-mail message.

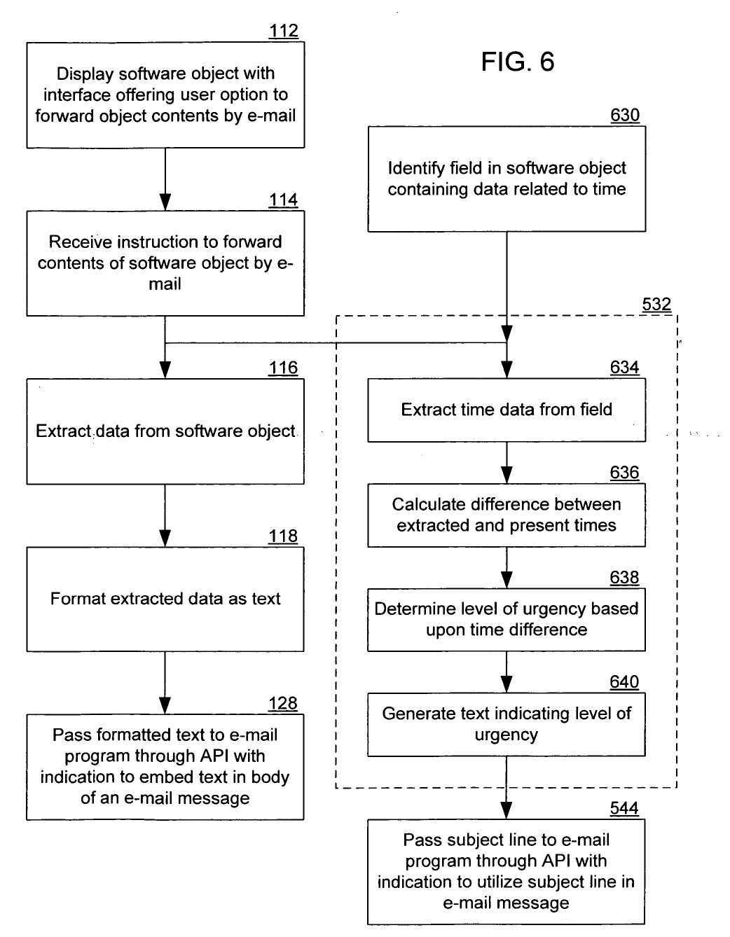

FIG. 6 illustrates a more detailed example of how the subject line data may be automatically generated to create an indication of urgency based on a deadline or due date found within the business object (1032). A field of the business object may be identified (630) as containing data related to time. This step of identifying may be performed, for example, by including a tag in the business object, by designating a particular field via a preferences interface, by prompting a user to identify which field of the object should be used for time data, and/or by scanning the fields of the object looking for data having the format of time data. Responsive to receiving the instruction to forward the contents of the business object by e-mail (114), the time data is extracted (634) from the identified time field. The application program (1030) then calculates (634) a difference between the extracted time data and the present time, and determined (638) a level of urgency based upon the calculated time difference. Text is then generated (640) as a subject line indicating the level of urgency.

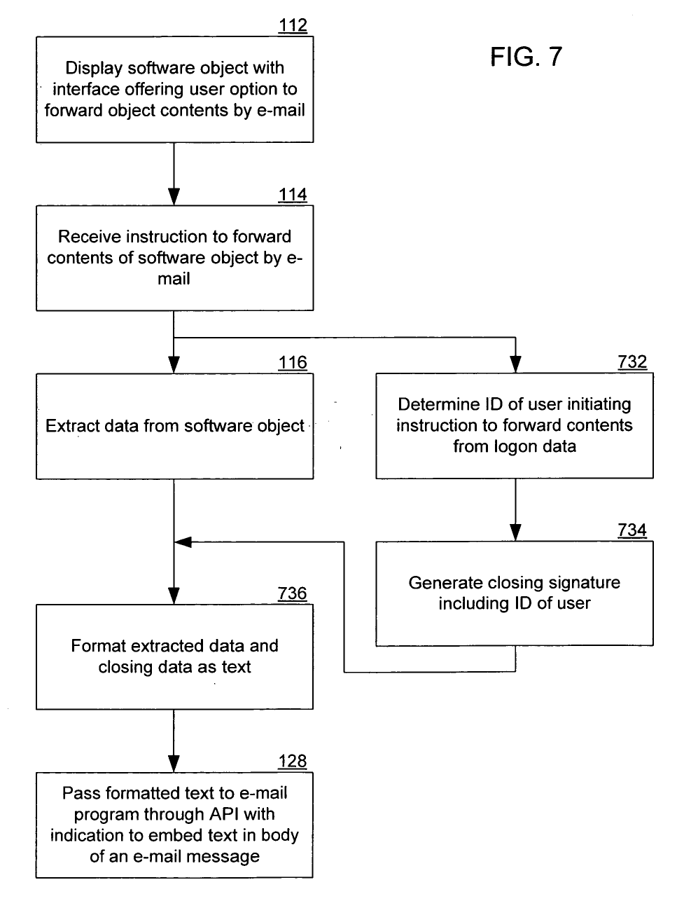

FIG. 7 illustrates an automatic routine for adding a closing signature to the body of the e-mail message. Responsive to receiving the instruction to forward the contents of the business object by e-mail (114), the application program (1030) determines (732) an identity of a user initiating said instruction to forward contents from logon data. A closing signature is then generated (734), including the identity of the user, which is then included in the formatted text (736) to be embedded in the e-mail message.

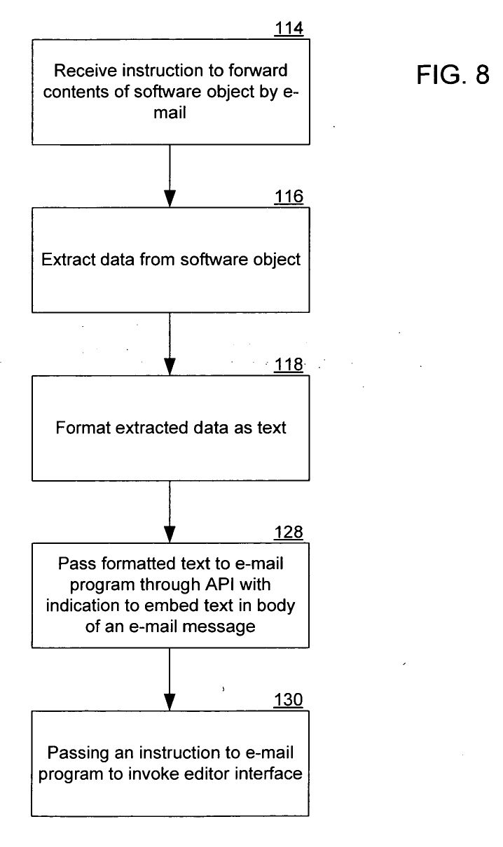

FIG. 8 illustrates a further automatic routine which passes (130) through the API (1042), with the formatted text, an instruction to the e-mail program to invoke an editor interface (1044), the editor interface to present the e-mail message for display and editing on a terminal on which said instruction to forward contents was initiated.

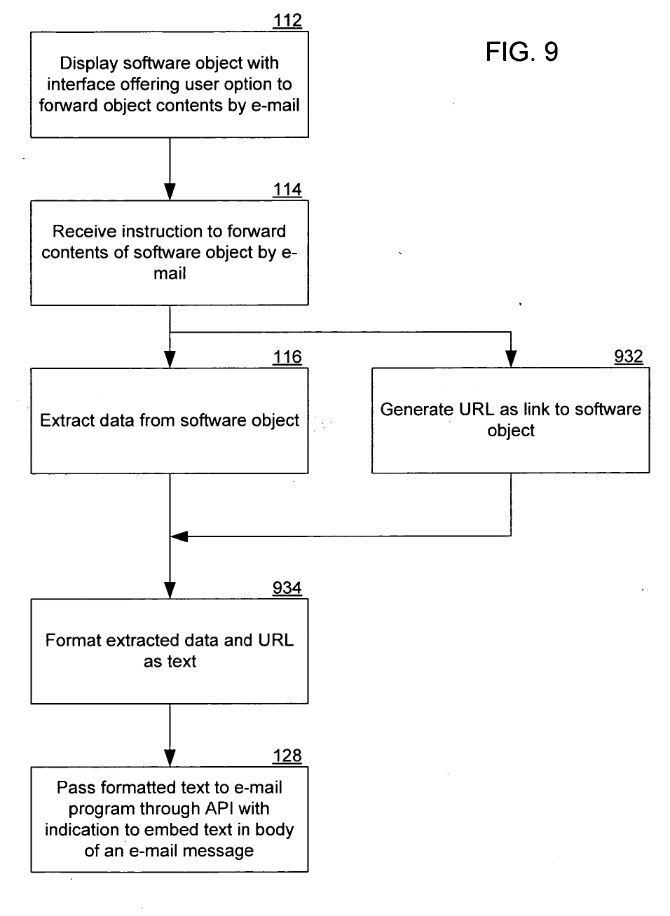

FIG. 9 illustrates a further automatic routine in which, responsive to receiving the instruction to forward the contents of the business object by e-mail (114), the application program (1030) generates (932) a uniform resource locator as a link to the software object, which is then included in the formatted text (934) to be embedded in the e-mail message.

Although the steps for formatting text for the body of the e-mail message (118, 436, 736) are illustrated as separate steps, they may be a same step.

In general, formatting the extracted data as text may comprise concatenating the extracted data with text corresponding to a meaning of the data in the business object. As described above, meaning can be determined among other ways from tags embedded in the software object, or from designations assigned to fields via a preferences interface.

The formatted text embedded in the body of the e-mail message may consist of a sequence of discrete characters encoded in an n-bit character set, where n >7, and the n-bit character set including discrete n-bit characters to represent letters, digits, punctuation, and carriage returns. Examples of such character sets include Unicode, ASCII, Extended Binary-Coded Decimal Interchange Code, Chinese National Standard GB18030, and various Japanese Industrial Standards character sets. The formatted text embedded in the body may be formatted in an editable format selected from plain text, Rich Text Format, and a syntactic Markup Language (e.g., HTML, XHTML).

FIG. 10 illustrates a computer system 1000 on which the above methods may be implemented. The computer system 1000 may comprise one or more processors, terminals, and/or computers. Computer system 1000 comprises a display and user interface 1010 and a processor and memory 1020. A database 1050 may be part of the computer system 1000, or may be distributed/located remotely over a network (not shown). An application program 1030 stored in the memory and executed on the process enables a user to interact with a business object 1032. An extraction subroutine 1034 performs data extraction from the business object 1032, if the user initiates a request to forward contents of the business object by e-mail, handling the process described above. The computer system 1000 also includes an e-mail program 1040 having an API 1042 and an interactive e-mail editor 1044.

The methods described above may be stored as instructions on a machine readable medium, that when executed, cause one or more computers to perform the various steps. For example, the computer system 1000 may each include a storage component for storing machine-readable instructions for performing the various processes described above and illustrated in FIGS. 1-9. The storage component may be any type of machine readable medium (i.e., one capable of being read by a machine) such as hard drive memory, flash memory, floppy disk memory, optically-encoded memory (e.g., a compact disk, DVD-ROM, DVD±R, CD-ROM, CD±R, holographic disk), a thermomechanical memory (e.g., scanning-probe-based data-storage), or any type of machine readable (computer readable) storing medium. The computer system may also include addressable memory (e.g., random access memory, cache memory) to store data and/or sets of instructions that may be included within, or be generated by, the machine-readable instructions when they are executed by the processor.

Several embodiments of the invention are specifically illustrated and/or described herein. However, it will be appreciated that modifications and variations of the invention are covered by the above teachings and within the purview of the appended claims without departing from the spirit and intended scope of the invention.

What is claimed is:

1. A method for exchanging data from a purchase order management system with another, comprising, responsive to a predetermined command:
generating a new e-mail message;
extracting entity data from an active business object and providing an e-mail address thereof in a recipient field of the e-mail message;
extracting purchase order data from the active business object;
providing the extracted purchase order data as text in a body of the e-mail message; and
transmitting the e-mail message.

2. A method for creating an e-mail including data from a business object instantiated in a purchase order management system, comprising:
responsive to an instruction to forward contents of the business object by e-mail, extracting data from the business object;
formatting the extracted data as text; and
passing the formatted text to an e-mail program through an application programming interface of the e-mail program with an indication to embed the formatted text in a body an e-mail message.

3. The method of claim 2, further comprising:
extracting e-mail address data from an e-mail address field of the business object; and
passing the extracted e-mail address data to the e-mail program through said application programming interface with an indication to utilize the extracted e-mail address data as a destination address of the e-mail message.

4. The method of claim 2, further comprising:
extracting the identity of the entity from an entity identity field of the business object;
querying a database for e-mail address data for the entity, providing the extracted identity of the entity to the database in the query; and
responsive to receiving the e-mail address data for the entity from the database, passing the e-mail address data to the e-mail program through said application programming interface with an indication to utilize the e-mail address data as a destination address of the e-mail message.

5. The method of claim 2, further comprising:
extracting an identity of the entity from an entity identity field of the business object;
generating a salutation including the extracted identity of the entity; and
incorporating the salutation into the formatted text prior to passing the formatted text to the e-mail program.

6. The method of claim 2, further comprising:
based upon data in the business object, generating subject line data for the e-mail message; and
passing the subject line data to the e-mail program through said application programming interface with an indication to utilize the subject line data as a subject line of the e-mail message.

7. The method of claim 6, wherein generating the subject line data comprises:
extracting time data from a time field of the business object;
calculating a difference between the extracted time data and a present time;
determining a level of urgency based upon the calculated difference; and
generating text indicating the level of urgency as the subject line data.

8. The method of claim 2, further comprising:
determining an identity of a user initiating said instruction to forward contents from logon data;
generating a closing signature including the identity of the user; and
incorporating the closing signature into the formatted text prior to passing the formatted text to the e-mail program.

9. The method of claim 2, further comprising:
passing, with the formatted text, an instruction to the e-mail program to invoke an editor interface, the editor interface to present the e-mail message for display and editing on a terminal on which said instruction to forward contents was initiated.

10. The method of claim 2, further comprising:
generating a uniform resource locator as a link to the business object; and
incorporating the uniform resource locator into the formatted text prior to passing the formatted text to the e-mail program.

11. The method of claim 2, wherein formatting the extracted data as text comprises:
concatenating the extracted data with text corresponding to a meaning of the data in the business object.

12. The method of claim 2, wherein the formatted text consists of a sequence of discrete characters encoded in a character set including discrete characters to represent letters, digits, punctuation, and carriage returns.

13. The method of claim 2, wherein the formatted text is in an editable format selected from plain text, Rich Text Format, and a syntactic Markup Language.

14. A machine-readable medium storing instructions adapted to be executed by a processor to perform a method comprising:
responsive to an instruction to forward contents of a software object by e-mail, extracting data from the software object;
formatting the extracted data as text; and
passing the formatted text to an e-mail program through an application programming interface of the e-mail program with an indication to embed the formatted text in a body an e-mail message.

15. The machine-readable medium of claim 14, the method further comprising:
extracting e-mail address data from an e-mail address field of the software object; and
passing the extracted e-mail address data to the e-mail program through said application programming interface with an indication to utilize the extracted e-mail address data as a destination address of the e-mail message.

16. The machine-readable medium of claim 14, the method further comprising:
extracting the identity of the entity from an entity identity field of the software object;
querying a database for e-mail address data for the entity, providing the extracted identity of the entity to the database in the query; and
responsive to receiving the e-mail address data for the entity from the database, passing the e-mail address data to the e-mail program through said application programming interface with an indication to utilize the e-mail address data as a destination address of the e-mail message.

17. The machine-readable medium of claim 14, the method further comprising:
extracting the identity of the entity from an entity identity field of the software object;
generating a salutation including the extracted identity of the entity; and
incorporating the salutation into the formatted text prior to passing the formatted text to the e-mail program.

18. The machine-readable medium of claim 14, the method further comprising:
based upon data in the software object, generating subject line data for the e-mail message; and
passing the subject line data to the e-mail program through said application programming interface with an indication to utilize the subject line data as a subject line of the e-mail message.

19. The machine-readable medium of claim 18, wherein generating the subject line data comprises:
extracting the time data from a time field of the software object;
calculating a difference between the extracted time data and a present time;
determining a level of urgency based upon the calculated difference; and
generating text indicating the level of urgency as the subject line data.

20. The machine-readable medium of claim 14, the method further comprising:
determining an identity of a user initiating said instruction to forward contents from logon data;
generating a closing signature including the identity of the user; and
incorporating the closing signature into the formatted text prior to passing the formatted text to the e-mail program.

21. The machine-readable medium of claim 14, the method further comprising:
passing, with the formatted text, an instruction to the e-mail program to invoke an editor interface, the editor interface to present the e-mail message for display and editing on a terminal on which said instruction to forward contents was initiated.
